(19) United States
(12) Patent Application Publication
(10) Pub. No.: US 2026/0217043 A1
(43) Pub. Date: Jul. 30, 2026

(54) DEVICE CUSTOMIZATION

(71) Applicant: Lenovo Global Technology (United States) Inc., Morrisville, NC (US)

(72) Inventors: Robert J. Kapinos, Durham, NC (US); Scott Li, Cary, NC (US); Robert James Norton, JR., Raleigh, NC (US)

(21) Appl. No.: 19/037,724

(22) Filed: Jan. 27, 2025

(51) Int. Cl. B41M 5/28; B41M 5/00

(52) U.S. Cl. CPC B41M 5/281; B41M 5/0052; B41M 2205/18

(57) ABSTRACT

One embodiment provides a method, the method including: identifying, using a device customization system, an image to be imprinted onto a surface of a device, wherein the surface of the device is coated with a layer of phase-change paint; identifying, using the device customization system, portions of the image; and generating imprinting instructions and transmitting the imprinting instructions toan imprinting component of the device customization system, wherein generating the imprinting instructions includes assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image. Other aspects are claimed and described.

### BACKGROUND

Many users utilize devices (e.g., laptop devices, tablets, personal computers, smart watches, cellular phones, smart phones, etc.) to perform many different functions. In many cases these devices are portable allowing the user to take them to many different locations. Entities may also provide devices to users to utilize, for example, schools may provide tablets to students, companies may provide laptops to employees, and/or the like. Accordingly, users or supplying entities may want to customize purchased or acquired devices. For example, users may want to put images (e.g., text, pictures, shapes, etc.) on a device surface in order to easily identify the device as their own, in order to show off their personality, and/or the like. Supplying entities may want to put images on a device surface in order to identify the device as belonging to the entity, include information of the device in a visible location, and/or the like.

### BRIEF SUMMARY

In summary, one aspect provides a method, the method including:
identifying, using a device customization system, an image to be imprinted onto a surface of a device, wherein the surface of the device is coated with a layer of phase-change paint; identifying, using the device customization system, portions of the image; and generating imprinting instructions and transmitting the imprinting instructions to an imprinting component of the device customization system, wherein generating the imprinting instructions includes assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.

Another aspect provides a system, the system including: an imprinting component; a processor; a memory device that stores instructions that, when executed by the processor, causes the system to: identify, using a device customization system, an image to be imprinted onto a surface of a device, wherein the surface of the device is coated with a layer of phase-change paint; identify, using the device customization system, portions of the image; and generate imprinting instructions and transmit the imprinting instructions to the imprinting component of the device customization system, wherein generating the imprinting instructions includes assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.

A further aspect provides a product, the product including: a computer-readable storage device that stores executable code that, when executed by a processor, causes the product to: identify, using a device customization system, an image to be imprinted onto a surface of a device, wherein the surface of the device is coated with a layer of phase-change paint; identify, using the device customization system, portions of the image; and generate imprinting instructions and transmit the imprinting instructions to an imprinting component of the device customization system, wherein generating the imprinting instructions includes assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for imprinting an image onto a surface of a device using phase-change paint.

FIG. 4 illustrates an example of three-layer phase-change paint with variable focus depth laser used to excite the material in each layer.

### DETAILED DESCRIPTION

Traditionally, when a user or entity wants to customize a device by putting an image on a surface of the device, the user or entity has few options. One technique for customizing a device is to create a sticker that has the desired image (e.g., text, picture, shapes, logo, etc.). The user or entity can then put the sticker on the device surface. A sticker allows a user to create whatever image is desired and the sticker can also be of whatever shape or size that is desired. Another advantage to the sticker is that it is removable, so if the user no longer wants the image attached to the device surface, the user can remove the sticker, and any residual stickiness. However, stickers are susceptible to being easily removed. Therefore, if the sticker was intended to designate that the device belonged to a particular user or entity, a person who intends to abscond with the device could easily remove the sticker to obfuscate the fact that the device actually belongs to someone else. Additionally, since stickers are generally temporary, stickers tend to fall off surfaces, particularly textured surfaces. Thus, the sticker may be removed from a surface before the user intends.

A more permanent technique for customizing a device includes utilizing a laser or acid etching to create a monochrome image onto a device surface. A laser may be used to remove or ablate off a surface coating of the surface to expose an area underneath the coating. Acid etching works similarly to remove a surface coating to expose an area underneath the coating. This results in a monochrome image on the surface of the device. However, the contrast between portions of the image is generally very low with the difference in portions being a texture or a very small change in color between the image portions. Thus, the etched image has very low contrast and very poor color. Additionally, these techniques are permanent. Once the image has been lasered or etched onto the surface, it is not removable. Additionally, by removing the coating from the surface of the device, the surface of the device is no longer protected by any protections that the removed coating provided. For example, some coatings may provide corrosion protection or other environmental protections.

Accordingly, the described system and method provides a technique for imprinting an image onto a surface of a device using phase-change paint. The device customization system identifies an image to be imprinted onto a surface of a device. The device surface is coated with at least one layer of phase-change paint. While the described system can be utilized with a single layer of phase-change paint, additional layers of phase-change paint can be utilized to provide for additional colors. For example, a single layer of phase-change paint can provide two different colors, resulting in a monochrome image. Two layers of phase-change paint can provide four different colors, if the two layers are different colors. Three layers of phase-change paint, where the layers are all different complementary colors, can provide 8 colors.

The device customization system identifies portions of the image. This includes identifying lines of the image, portions of the image having a different color as compared to other portions, shading of the image, and/or the like. The device customization system then transmits instructions to imprint, using an imprinting component, the image onto the surface of the device. In generating the imprinting instructions to imprint the image, the device customization system assigns each of the portions a color that is enabled by the phase-change paint. The imprinting instructions are created to change the phase-change paint to create the image based upon the colors assigned to the portions of the image. When more than one layer of phase-change paint is utilized, the imprinting instructions may include changing more than one layer to create the assigned color.

Therefore, a system provides a technical improvement over traditional methods for customizing a surface of a device. The described system and method provide a technique for customizing device surfaces using phase-change paint that allows for color images to be imprinted onto a device surface. The described system and method provide a customization technique that is not removable until a re-writing component is utilized to remove the image as compared to the use of stickers or other similar techniques that are easily removed. Additionally, the system and method provides a technique for customizing a device surface in a manner that is not destructive as compared to laser or acid etching techniques. Also, unlike the laser or acid etching techniques, the customization technique of the described system does not remove the protections of the equipment provided through the surface coatings. Additionally, the described system and method provides an image that is a higher quality image in terms of color and contrast as compared to conventional monochrome techniques.

The illustrated example embodiments will be best understood by reference to the figures. The following description is intended only by way of example, and simply illustrates certain example embodiments.

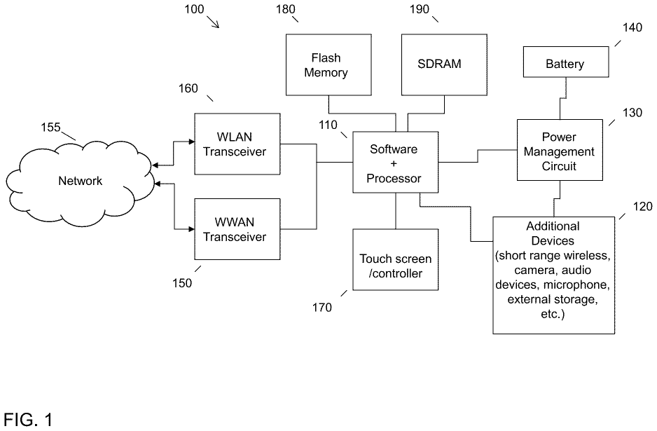

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

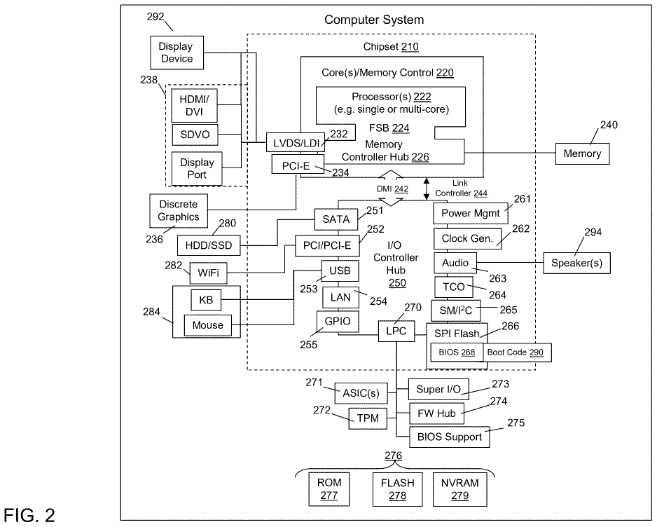

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices which may be customized using the device customization system, house or provide access to the device customization system, and/or the like. For example, the circuitry outlined in FIG. 1 may be implemented in a tablet or smart phone embodiment, whereas the circuitry outlined in FIG. 2 may be implemented in a personal computer embodiment.

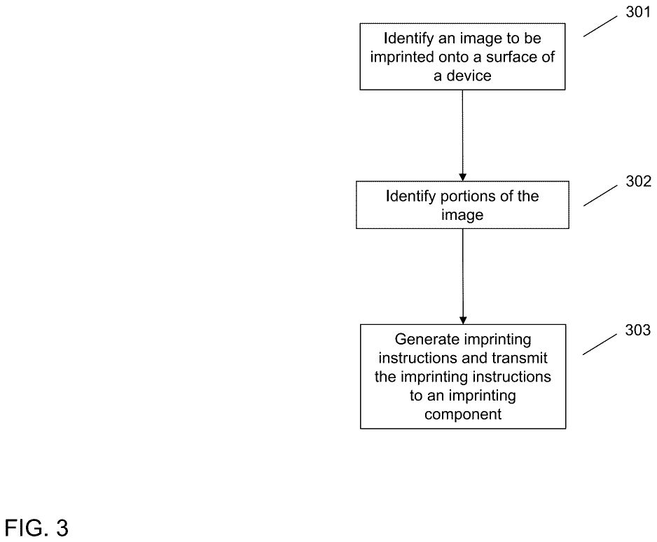

FIG. 3 illustrates an example method for imprinting an image onto a surface of a device using phase-change paint. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to imprint an image onto a surface of a device using phase-change paint. Additionally, the device customization system includes modules and features that are unique to the described system.

The device customization system may be activated in order to customize a device surface that has been coated with phase-change paint. Thus, the device customization system may be activated upon detecting that a user or entity desires to customize a device surface. For example, the device customization system may identify that a user has provided an image into the device customization system, that a user has placed a device surface at a location where the surface can be imprinted, and/or the like. Once the device customization system determines that an image is to be imprinted onto a device surface, the system can generate instructions that can be utilized by an imprinting component to imprint the image onto the surface of the device.

The device customization system may include an imprinting component, which may be a laser, a polarized light source, a temperature source, a directed magnetic source, a vibration source, and/or the like, that can be utilized to change the phase of the paint in order to alter its color. In some embodiments, a single imprinting component has its focal length varied to cause phase changes at the different depths of the paint layers, in the example where multiple paint layers are utilized. In some embodiments, the imprinting component may use wavelengths that are transparent to some layers to only affect other layers. In some embodiments, the layers may be susceptible to different forms of radiation or vibration so they are selectively altered. The device customization system may write images onto the device as a bulk print action, as a sequential series of point applications, as parallel series of relatively small write actions, and/or the like.

The device customization system may also include an erasing component that can be used to remove the image from a device surface. Erasing components work by returning the phase-change paint material to its original phase. The original phase may be organized or disorganized. The erasing component may be a device similar to the imprinting component except that it may have a different characteristic that reverses the imprinting. For example, if the imprinting component is a laser, the erasing component may be a laser that produces a laser output having a different frequency as compared to the imprinting component. To utilize the erasing component, the phase-change paint may need to be a particular type of phase-change paint that allows for the erasing and re-writing of the phase-change paint.

Activation of the device customization system may be a manual activation of the device customization system and/or an automatic activation of the device customization system. Manual activation of the system may include a user opening an application associated with the device customization system, the user accessing the computing system associated with the device customization system, and/or the user otherwise providing input to the device customization system. The automatic activation of the device customization system may be based upon the detection of a trigger event indicating that the system should be activated. Example trigger events include the user providing an image to the device customization system, the user placing a device surface at a particular location with respect to the device customization system, a user accessing an application that interfaces with the device customization system, activation of software or an application utilizing the device customization system, and/or the like.

The device customization system may be made of multiple systems or modules that communicate together to make up the device customization system or may be a single system. The device customization system may be a standalone system, may be accessible through other computing devices, and/or a combination thereof. For example, the device customization system may be a standalone system that can be accessed by a user and/or may be or provide an application that is accessible by a user on another computing device. The device customization system may be accessible using any type of computing device, for example, personal computer, laptop computer, smartphone, tablet, smartwatch, head-mounted display, smart television or other smart appliance, augmented reality device, virtual reality device, and/or the like. Thus, the device customization system may be accessible locally using a computing device where the device customization system is installed and/or may be accessible remotely through another computing device. For example, the device customization system may be accessed by a user using a device that communicates with the device customization system to imprint an image onto a surface of a device that has been coated with phase-change paint, identify portions of the image, transmit instructions to imprint the image onto the surface of the device, and/or the like. However, the device customization system may be located and operate on a different information handling device to perform the described steps.

The identification of an image and generation of instructions to imprint an image onto the surface of a device can be provided as a service to other entities or companies. In other words, the device customization system could be stored on a server or network of a company and the system could identify the image and generate the imprinting instructions for imprinting the image onto the surface of the device, with the other companies or entities paying for the generation of the imprinting instructions or use of the device customization system. Thus, the company could identify the image and create a file from the image where the image has been converted to a file that can be accessed and read by the imprinting component so that the image can be imprinted onto the surface of the device that has been coated with the phase-change paint. The file can then be transmitted to the other company or entity for the performance of the actual imprinting of the image onto the surface of the device.

The device customization system may have an associated graphical user interface. The graphical user interface may be provided on a display or monitor, which may or may not be associated with the device customization system. In other words, the device customization system may have a dedicated display or monitor or may be accessible using any display or monitor. In either case, the device customization system may provide instructions to generate and display the graphical user interface on the display device being used to access the device customization system. The graphical user interface may also be updated and managed based upon instructions provided by the device customization system. In other words, the device customization system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the device customization system. For example, the device customization system may utilize a user profile, historical information, and/or the like, to identify an image, generate instructions for imprinting an image on a surface of a device that has been coated by phase-change paint, and/or the like. The graphical user interface may allow for creation of or access to these profiles, historical information, and/or the like, by allowing a user to input information regarding user preferences, device information, and/or the like. As will be discussed in more detail, the use of user provided information is not the only way that the profile and/or historical information can be created. The device customization system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, and/or the like. It should be noted that the information to be used by the device customization system and information provided by the device customization system can be different for different applications, different computing systems, different users, and/or the like. Thus, the information corresponding to input or output of the device customization system are not always the same. However, the device customization system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The device customization system may include different components for carrying out different functions of the system, including different steps to be performed. These components may be hardware components or software components. Some hardware devices or components that may be utilized by the device customization system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the device customization system. For example, the device customization system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the device customization system, and/or the like.

Additionally, the device customization system may include hardware components to perform the imprinting of an image onto a surface of a device and to erase images from a surface of a device. The imprinting component may be a laser, heat producing component, or other type of component that can change a color of phase-change paint. Phase-change paint or compounds therein may undergo a chromism process that induces a change in the colors of compounds. Chromism may be based upon a change in the electron state of molecules. Accordingly, chromism may be induced using different stimuli, for example, heat (thermochromism), light (photochromism), electric current (electrochromism), a polarity of a solvent (solvatochromism), and/or the like. As an example of thermochromism, some liquid crystals are capable of displaying different colors at different temperatures. Thus, upon application of different temperatures to the liquid crystal result in a change to the color displayed by the liquid crystal.

Phase-change paint or compounds may also include a crystalline structure that changes upon the application of light at a particular wavelength, heat, and/or the like. For example, output from a laser at a particular wavelength may excite the crystals within the phase-change paint so that they reflect a particular color. The wavelength of the laser needs to be matched to the phase-change paint color. Similarly, as another example, some phase-change paint may respond to the application of heat. Thus, the imprinting component may output heat at a particular temperature to change the color of the phase-change paint.

In the event that the phase-change paint allows for re-writing the phase-change paint. In other words, the phase-change paint can be changed back to the original form, thereby “erasing” the image that was imprinted onto the surface. The phase-change paint can then be written with a new image. The phase-change paint may need to have a particular chemistry in order to allow the phase-change paint to be written and erased. Thus, not all phase-change paint may allow for the image to be erased. To erase the image, the device customization system may include an erasing component. The erasing component may be similar to the imprinting component, but may have a different characteristic as compared to the imprinting component. For example, the erasing component may be a laser like the imprinting component. However, the erasing component may operate at a different frequency as compared to the imprinting component. In other words, the laser output may have a different frequency between the imprinting component and the erasing component. As another example, the erasing component may be a heat source, but may provide an output at a different temperature as compared to the writing component. The erasing component can be used to revert the structure of the phase-change paint to an unexcited or un-written state.

The surface of the device may be coated with more than one layer of phase-change paint. Thus, the imprinting component and/or erasing component may be designed or may be adjustable to provide different outputs that can change each layer of the phase-change paint. For example, where each layer of the phase-change paint is a different color, the output of the imprinting component and/or erasing component may be varied in order to coincide with the color of the layer to change each of the individual layers. For example, using the laser example, the wavelength of laser output may be changed to coincide with the color of an individual layer.

In the case of multiple layers of phase-change paint, the imprinting component and/or erasing component may be built as a multi-scanning device that goes over the surface of the device multiple times with different output sources (e.g., lasers, temperature sources, etc.). In other words, the component will have an output source that is configured having a particular output characteristic (e.g., wavelength, temperature, etc.) that coincides with one of the layers. The component will then go over the surface with this output characteristic. The output characteristic will then be changed to coincide with a different of the layers. The component will then go over the surface with this output characteristic. This will continue until all the layers have been changed to conform with the image. Alternatively, the imprinting component and/or erasing component may be built as a single scanning device that has multiple output sources, with each of the output sources configured to a particular output for one of the layers. Thus, the single scanning device will go over the surface of the device a single time and change all the layers at the same time to conform with the image.

The imprinting and/or erasing component may include technology that allows the laser to adjust for curved and/or textured surfaces. Thus, the described system and method is not confined to either flat and/or smooth surfaces. The imprinting and/or erasing component may include self-focusing technology that allows for the component to adjust for changes in the surface, for example, due to texture, due to curvature, and/or the like. Thus, the imprinting and/or erasing component can self-adjust the tracking of the component to account for these changes.

One software component may include a data storage location or data repository that stores information related to images, device surfaces, instructions, user profiles, and/or the like. The data storage location or data repository may also store information related to the imprinting and/or erasing components, for example, identifiers, models, types, manufacturers, output characteristics, output sources, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by image, grouped by user, grouped by component type, and/or the like.

Another software component includes a user profile that stores information related to a user and user preferences, an image profile that stores information related to an image and color assignments, an imprinting and/or erasing component that stores information related to characteristics of an imprinting and/or erasing component, and/or the like. The device customization system may utilize information contained within the profiles to identify images to be imprinted onto a surface, identify portions of an image, generate instructions for an imprinting and/or erasing component, and/or the like. Thus, the profiles may include information that can be used by the device customization system for performing these steps. This information may be identified by the user through manual input, or identified by the device customization system as changes are made. In other words, information within the profiles may be learned by the device customization system over time. Thus, the device customization system can monitor inputs provided by a user, by an entity, by a system, and/or the like.

Accordingly, any of the mentioned profiles, or other profiles, may include additional information that may be useful for the device customization system and may be entered by a user, may be default values, may be learned by the system over time, and/or the like. Thus, profiles can be populated with information manually by a user, entities or companies, and/or the like, or can be populated over time as the system learns more about the user, images, entities or companies, customizations, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may provide inputs (e.g., audible inputs, visual inputs, gesture inputs, etc.) that indicate that the user would like to control a characteristic of an external device, and/or the like. The system can then aggregate this information to learn preferences of the user. Similarly, the system can learn information for other profiles. With respect to the described device customization system, the learned information may include historical information, identification of conversions of images to instructions for imprinting the image, identification of color assignments for image portions, and/or the like.

Another software component includes a software component that can process images and turn the images into files or a format that is accessible and readable by the imprinting and/or erasing component. Thus, the image conversion software component can analyze an image, identify different portions of the image, and generate a file or format that is readable by the imprinting and/or erasing component. The image conversion software may be utilized to identify colors within the image and assign colors to the image. The assigned colors are those colors which are enabled by the phase-change paint. Thus, the assigned colors may not match the colors of the image. For example, if the phase-change paint only provides two different colors, an image having four different colors will be assigned only the two colors enabled by the phase-change paint. Thus, the image conversion software will make a determination regarding which portions of the image will be assigned to a particular color, even if those colors may not match the colors of the original image.

At 301, the device customization system identifies an image to be imprinted onto a surface of a device. Identifying an image may include receiving input indicating that an image is to be imprinted onto a surface of a device. Receiving input may include a user providing input to the graphical user interface indicating that an image is to be imprinted onto the surface of a device. Within the graphical user interface, the input may identify the image to be imprinted and may also identify the surface and/or device to which the image is to be imprinted. The input within the graphical user interface may include uploading or otherwise adding the image to the graphical user interface, providing a link to a file of the image, providing instructions for accessing the image, and/or the like. The image may also be created within the graphical user interface. The graphical user interface of the device customization system may be similar to other graphical user interfaces that take user input and convert it to a machine-readable format or machine-readable instructions for performing some function in relation to an image, for example, drawing programs, water jet cutters, craft cutters, printers, and/or the like. Receiving input may also be performed outside the graphical user interface, may be input of any modality (e.g., text input, selection input, audible input, gesture input, image input, etc.), and/or the like. Other techniques for identifying the image are contemplated and possible.

Identification of the surface and/or device that the image is to be imprinted upon may include an identification of the type of device, identification of dimensions of the device, scanning the device, placement of the device at a predetermined location, and/or the like. As an example, the device customization system may have a platform or other area for placement of the device upon which the image is to be imprinted. If the device is placed on this platform or at the area, the system may scan the device, for example, using an image capture device, a scanner, and/or the like, and identify the surface of the device that the image is to be imprinted upon. This identification may include identifying dimensions and any other characteristics of the surface, for example, any curvature of the surface, texture of the surface, color of the phase-change paint, number of layers of the phase-change paint, and/or the like. Other techniques for providing identification of the surface and/or device are contemplated and possible. For example, the user could provide input identifying the surface and/or device within the graphical user interface, the user could select the device and/or surface from a menu, the system could receive a file with the information, and/or the like.

The surface of the device has been coated with a layer of phase-change paint. Phase-change paint is paint that changes color when exposed to a particular output, for example, temperature, light, light at specific wavelengths, and/or the like. For example, phase-change paint may change color when exposed to a specific temperature, when exposed to intense light of a specific wavelength, when exposed to a strong directed magnetic field, when exposed to a directed vibration, and/or the like. To change the color of the phase-change paint, the crystalline structure may be changed, the molecular structure may be changed, atomic grain domains may be altered, and/or the like. The portion of the phase-change paint that is changed to result in the color may be based upon the type of phase-change paint that is utilized. More than one phase-change paint technology can be combined to gain the desired color combinations.

The phase-change paint may be associated with a particular color that, when exposed to the output, appears in the paint. For example, the phase-change paint may be reactive to a light emitted at a particular wavelength and may be associated with the color magenta. When the phase-change paint is exposed to the wavelength, the phase-change paint turns the magenta color. Before the phase-change paint is exposed to the wavelength it will be referred to as non-activated phase-change paint. The non-activated phase-change paint may have a neutral or color, for example, gray, silver, white, black, clear, and/or the like. However, the non-activated phase-change paint could be any color. A single layer of phase-change paint may result in the ability to create a two-color image, where one color is associated with the non-activated phase-change paint and the other color is associated with the activated phase-change paint.

The surface of the device may be coated with more than one layer of phase-change paint. The inclusion of additional layers of phase-change paint may allow for additional colors to be made using the combination of layers of the phase-change paint. Accordingly, the layers of the phase-change paint may be semi-transparent so that layers underneath other layers are visible or can be combined with colors of other layers to create a combined color. While the layers of the phase-change paint could be the same color, more colors are possible if the layers of the phase-change paint are different colors. For example, two layers of phase-change paint that are different colors would result in four possible colors, due to a combination of different combinations of the layers being activated or deactivated. As another example, three layers of phase-change paint that are not only different colors, but that are complementary colors allows for three-bits of color, which results in any possible color. In other words, different combinations of the layers can be activated to produce different colors.

The layers are chosen so as to be appealing and useful in the color space combination when all layers are applied. In other words, since the upper layers have colors biases and reflect some light, lower layers are chosen to reflect the dimmer and biased light that reaches them. In this way, the total reflected color from each layer combination is the desired one, even though the paint on a given layer might not be directly represented. The reflectance of the substrate onto which the paint is applied may also affect the total reflected colors, so this bias must also be accounted for when choosing layer colors. In some embodiments, a layer of static reflective paint may be applied under the phase-change paint to provide a controlled base color and reflectivity. It should be noted that while some phase-change paint may be either activated or deactivated, some phase-change paint may allow for a gradient change. Thus, even if the phase-change paint allows for gradient change, the device customization system could be utilized and whatever technique is utilized to cause a gradient change in the phase-change paint can be implemented.

The phase-change paint that is coated onto the surface of the device may be a phase-change paint that only allows for a single image creation. Using such a phase-change paint means that the image that is made will be permanent once it is made. Some phase-change paints also are rewritable phase-change paints. Using the rewritable phase-change paint allows for an image to be created, the image to be erased, a new image to be created, and so on. Thus, such rewritable phase-change paints allow for multiple rewrites. This may be useful for users or entities who may want to change the image at least periodically.

At 302, the device customization system identifies portions of the image. The identification of the portions of the image may be performed based upon an image analysis, artificial intelligence model, user input, and/or the like. Identifying portions of the image may include identifying portions of the image that have a different contrast as compared to other portions of the image. For example, identifying portions may include identifying lines, shading, colors, and/or the like, of the image. How the different portions are identified may be based upon how many colors are enabled by the phase-change paint. For example, if a single layer of phase-change paint is utilized the enables two separate colors, identification of the portions may include identifying those portions which would create a discernable image if produced in a different color as compared to the other portions. Thus, in this example, the device customization system may identify the lines of the image as one portion and all other parts of the image as another portion.

The more colors that are enabled by the phase-change paint (for example, through an increase in the number of layers, through the use of gradient phase-change paint, and/or the like) allows for the designation of a number of portions less than or equal to the number of colors enabled by the phase-change paint. For example, if an image is a color image and the phase-change paint enables the production of many different colors, each portion of the image corresponding to a color may be designated as a different portion of the image. Those, those portions of the image corresponding to the same color will be designated as the same portion.

At 303, the device customization system generates and transmits imprinting instructions to cause the imprinting component to imprint the image onto the surface of the device. To generate the imprinting instructions, the device customization system may assign each of the portions identified at 302 a color that is enabled by the phase-change paint. The colors that are assigned to the different portions may either conform the colors of the image identified at 301, or could be different colors than those of the image. Whether the colors of the image are matched may be based upon what colors are enabled by the phase-change paint, may be based upon selections or inputs by a user, may be learned by the device customization system over time, may be default values, and/or the like. Once the colors have been assigned to the different portions, the device customization system may convert the image into a machine-readable format or file that can be accessed or read by the imprinting component of the device customization system. The file format may contain one section for all of the image, or it may contain separate sections for each layer to be printed. The imprinting component may print all colors on one pass, or it may print each layer sequentially depending on its implementation.

Generating the imprinting instructions may also include modifying the image, which may occur before the image is converted to a machine-readable format. One way that the image may be modified is a modification to the size of the image. The size of the image may be modified to fit onto the surface of the device or to fulfill a requirement by the user. Thus, the size of the image may be increased or decreased depending on the size of the surface and conditions of a user. Another modification that may be made is a simplification of the image based upon a number of colors enabled by the phase-change paint. For example, if the phase-change paint only enables two different colors, the image may need to be simplified to exclude shading or finer details or converted to a line drawing so that the image can be represented by only two colors. Other modifications that may be made include, but are not limited to, straightening the image, addressing clarity issues, modifying colors based upon user input, modifying saturation of colors, and/or any other image processing that can be performed.

To perform the imprinting, the device customization system may utilize the imprinting component. The imprinting affects the phase-change paint to create the image based upon the colors that are assigned to the portions of the image. Thus, it should be noted that while the term “imprinted” is utilized, it should be noted that this process is a change in the phase-change paint that results in a different color being visible as compared to the color of the phase-change paint when in a deactivated state. Thus, imprinting of the image is not the deposition or ablation of material onto or from the surface of the device, but rather the change of the phase-change paint to make a different color enabled by the phase-change paint visible. Thus, imprinting includes by affecting the phase-change paint based upon the colors that are assigned to the portions of the image.

In the case that multiple layers of phase-change paint are coated onto the surface of the device, one or more of the colors assigned to a particular portion may be made via a combination of more than one of the layers. In other words, a color may be created via a combination of two or more colors. Each of the colors of the combination can be associated with one of the layers. Thus, the color that is a combination of colors can be created by changing the layers associated with the colors of the combination.

In the case that a phase-change paint is utilized that is rewritable, the device customization system may remove the image from the surface of the device using the erasing component of the device customization system upon receiving instructions to do so. These instructions can be provided using any of the same techniques as discussed in connection with identifying an image to be imprinted onto the surface of the device. The surface of the device could then be imprinted with a new image using the method as previously described.

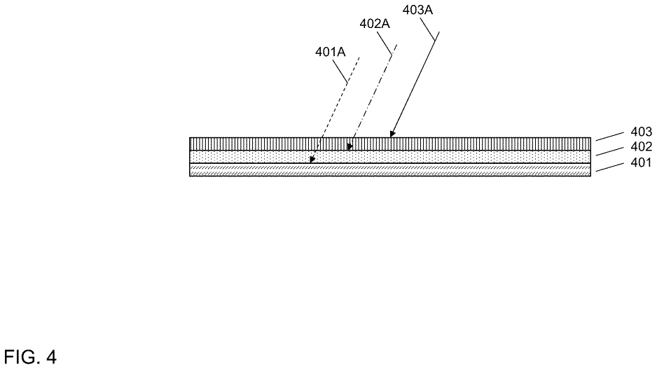

FIG. 4 illustrates an example of three-layer phase-change paint with variable focus depth laser used to excite the material in each layer. Using three-layer phase-change paint having three semi-transparent layers of complementary colors allows for 8 colors to be displayed. In order to excite each of the different layers, a characteristic of the imprinting component will be controlled to result in the emission from the imprinting component to reach the desired layer. Thus, the characteristic is selected so as to reach the depth of the desired layer. For example, in the case that a laser is utilized as the imprint device, the laser focal point can be changed so as to reach the depth of the desired layer. Utilizing FIG. 4 as an example, to change the color of layer 401, which is a different color than layer 402 and 403, the laser focal point will be changed so that the laser 401A reaches layer 401. Similarly, to change the color of layer 402, the laser focal point will be changed so that the laser 402A reaches layer 402. Additionally, to change the color of layer 403, the laser focal point will be changed so that the laser 403A reaches layer 403. The focus changes can be made at each writing spot to change all layers substantially simultaneously, or focus can be maintained to write each layer in sequential passes.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using a device customization system, an image to be imprinted onto a surface of a device, wherein the surface of the device is coated with a layer of phase-change paint;
identifying, using the device customization system, portions of the image; and
generating imprinting instructions and transmitting the imprinting instructions to an imprinting component of the device customization system, wherein generating the imprinting instructions comprises assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.

2. The method of claim 1, wherein the layer of phase-change paint of the device is a first layer of semi-transparent phase-change paint, and wherein the device further comprises a second layer of semi-transparent phase-change paint, wherein each of the first and second layers are different colors and the different colors are complementary colors.

3. The method of claim 2, wherein the color of at least one of the identified portions comprises a color made via a combination of the different colors and wherein the changing the phase-change paint comprises changing a plurality of the layers to result in the color of at least one of the identified portions.

4. The method of claim 2, wherein the changing the phase-change paint comprises modifying a characteristic of the imprinting component to change the phase-change paint of a given of the layers.

5. The method of claim 1, wherein the phase-change paint comprises re-writable phase-change paint.

6. The method of claim 5, comprising removing, using an erasing component of the device customization system, the image from the surface of the device.

7. The method of claim 1, wherein the changing the phase-change paint comprises changing a crystalline structure of the phase-change paint to result in the color.

8. The method of claim 1, wherein the generating the imprinting instructions comprises converting the image to a machine-readable format.

9. The method of claim 1, wherein the identifying the portions comprises identifying portions have a different contrast as compared to other of the portions.

10. The method of claim 1, wherein the imprinting component comprises a component selected from the group consisting of: a laser, a polarized light source, a temperature source, a directed magnetic source, and a vibration source.

11. A system, the system comprising:
an imprinting component;
a processor;
a memory device that stores instructions that, when executed by the processor, causes the system to:
identify, using a device customization system, an image to be imprinted onto a surface of a device, wherein the surface of the device is coated with a layer of phase-change paint;
identify, using the device customization system, portions of the image; and
generate imprinting instructions and transmit the imprinting instructions to the imprinting component of the device customization system, wherein generating the imprinting instructions comprises assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.

12. The system of claim 11, wherein the layer of phase-change paint of the device is a first layer of semi-transparent phase-change paint, and wherein the device further comprises a second layer of semi-transparent phase-change paint, wherein each of the first and second layers are different colors and the different colors are complementary colors.

13. The system of claim 12, wherein the color of at least one of the identified portions comprises a color made via a combination of the different colors and wherein the changing the phase-change paint comprises changing a plurality of the layers to result in the color of at least one of the identified portions.

14. The system of claim 12, wherein the changing the phase-change paint comprises modifying a characteristic of the imprinting component to change the phase-change paint of a given of the layers.

15. The system of claim 11, wherein the phase-change paint comprises re-writable phase-change paint.

16. The system of claim 15, comprising removing, using an erasing component of the device customization system, the image from the surface of the device.

17. The system of claim 11, wherein the changing the phase-change paint comprises changing a crystalline structure of the phase-change paint to result in the color.

18. The system of claim 11, wherein the identifying the portions comprises identifying portions have a different contrast as compared to other of the portions.

19. The system of claim 11, wherein the imprinting component comprises a component selected from the group consisting of: a laser, a polarized light source, a temperature source, a directed magnetic source, and a vibration source.

20. A product, the product comprising:
a computer-readable storage device that stores executable code that, when executed by a processor, causes the product to:
identify, using a device customization system, an image to be imprinted onto a surface of a device, wherein the surface of the device is coated with a layer of phase-change paint;
identify, using the device customization system, portions of the image; and
generate imprinting instructions and transmit the imprinting instructions to an imprinting component of the device customization system, wherein generating the imprinting instructions comprises assigning each of the identified portions of the image with a color that is enabled by the phase-change paint, and wherein the imprinting instructions are configured to cause the imprinting component to imprint the image onto the surface of the device by affecting the phase-change paint based upon the colors that are assigned to the portions of the image.
